(19) United States
(12) Patent Application Publication
(10) Pub. No.: US 2005/0283662 A1
(43) Pub. Date: Dec. 22, 2005

(54) Secure data backup and recovery

(76) Inventors: Yi Q. Li, Skokie, IL (US); Ezzat A. Dabbish, Cary, IL (US); Dean H. Vogler, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 10/872,723

(22) Filed: Jun. 21, 2004

(51) Int. Cl. G06F 11/00

(52) U.S. Cl. 714/13

(57) ABSTRACT

A technology provides secure data backup and recovery for an electronic device (100) having a device identification (115) that is unique and unalterable. A method of the technology includes identifying (205) backup data (405, 805, 1205) to be backed up, encoding (210) a backup data set by coding the device identification (115) and the backup data (405, 805, 1205) for integrity and authentication using a cryptographic key (110) and an integrity function, generating (220) decoded backup data (635, 1015, 1435) and decoded device identification (640, 1020, 1440) by decoding a retrieved backup data set (605, 1005, 1405) using the the cryptographic key (115) and the integrity function, and restoring (225) the backup data with the decoded backup data only when the integrity has been verified and the decoded device identification and the device identification match. Three methods of encoding and decoding are described.

### FIELD OF THE INVENTION

This invention is in the general technology area of data storage methods and more specifically, in the area of secure data backup.

### BACKGROUND

As electronic devices become more sophisticated, they are more likely to operate from program instructions that are downloaded and resident in read/write memory such as random access memory or disk drive memory. Information acquired or generated by a user of such devices may also be kept in such memory. Cellular telephones are one example of such electronic devices. Games and other applications can be downloaded. The read/write memory devices are fallible, so it would be desirable for a user to be able to back up the information stored in such devices.

In the case of games and applications that are downloaded, the entity that provides the software has typically licensed the software for use only in the device to which it has been downloaded, and would therefore prefer some assurance that it is only copied and only used for backup purposes for the device to which it has been licensed. This is a digital rights issue. A user may also desire that backup information that the user has generated be securely backed up such that it can only be restored to the user's device by which it was generated. For example, a backup service may be provided by a third party in whom the user does not have absolute trust. Thus there is need for a secure backup technology that allows restoration only in the device which performs the backup. The user may also be concerned about privacy of his backup data. For example, the user may desire that credit card information or medical records be encrypted (for privacy). Furthermore, the user may only trust the device in which the data resides and from which the backup will be made, and would want assurance that the data can be recovered only by the device in which the user created the backup.

### BRIEF DESCRIPTION OF THE DRAWINGS

The present invention is illustrated by way of example and not limitation in the accompanying figures, in which like references indicate similar elements, and in which:

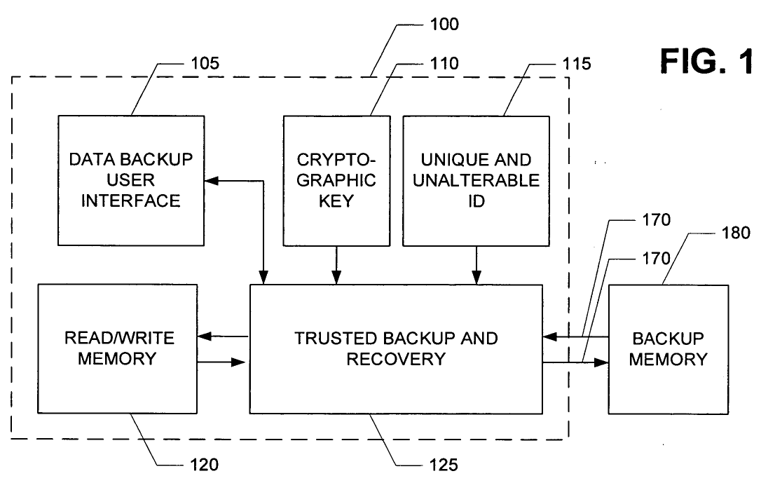

Referring to FIG. 1, a functional block diagram shows portions of an electronic device and a backup memory, in accordance with some embodiments of the present invention;

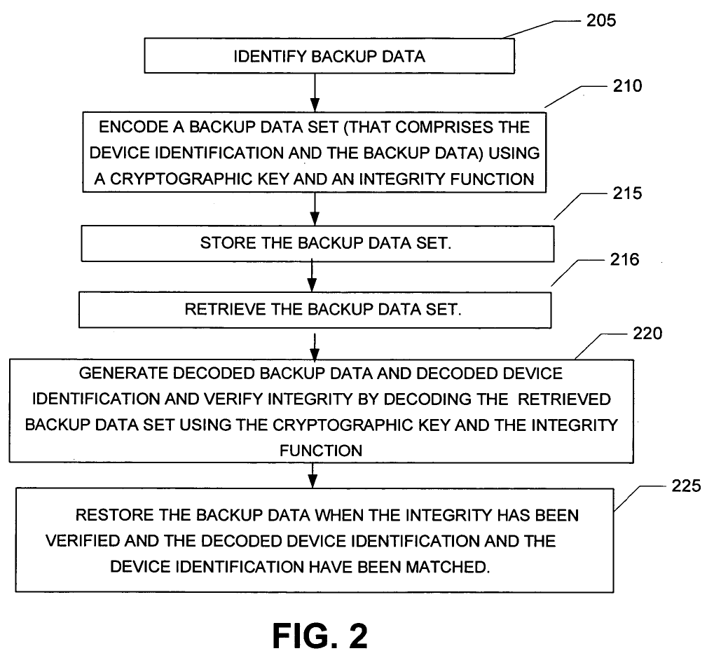

Referring to FIG. 2, a flow chart of a method for secure data backup and recovery is shown, in accordance with some embodiments of the present invention;

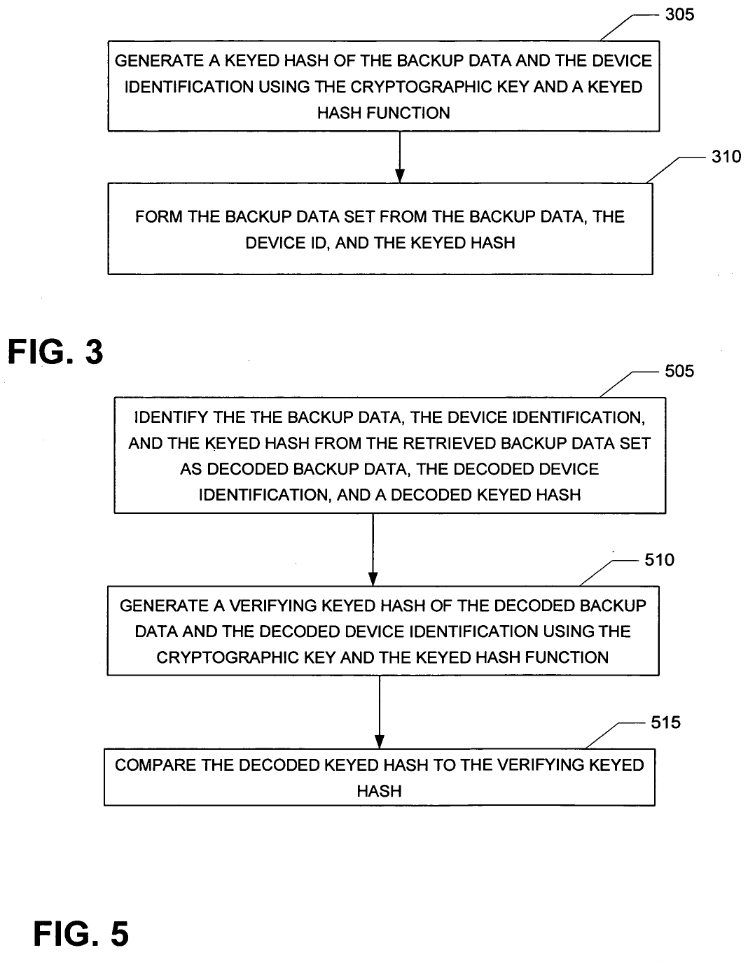

Referring to FIGS. 3, 4, 5, and 6, flow charts of methods and data flow diagrams for the encoding and decoding of the backup data set are shown, in accordance with embodiments of the present invention of a first type; and

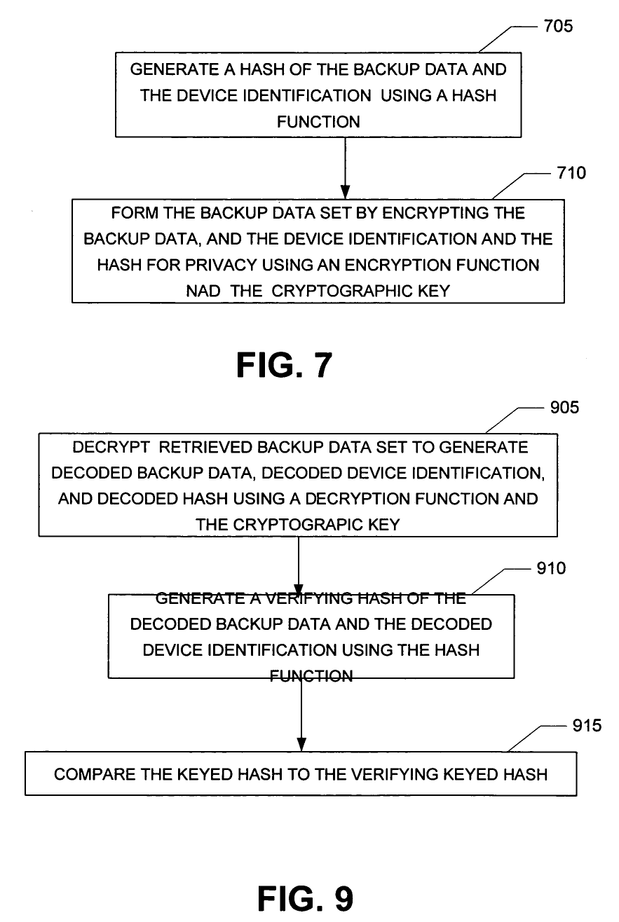

Referring to FIGS. 7, 8, 9, and 10, flow charts of methods and data flow diagrams for the encoding and decoding of the backup data set are shown, in accordance with embodiments of the present invention of a second type; and

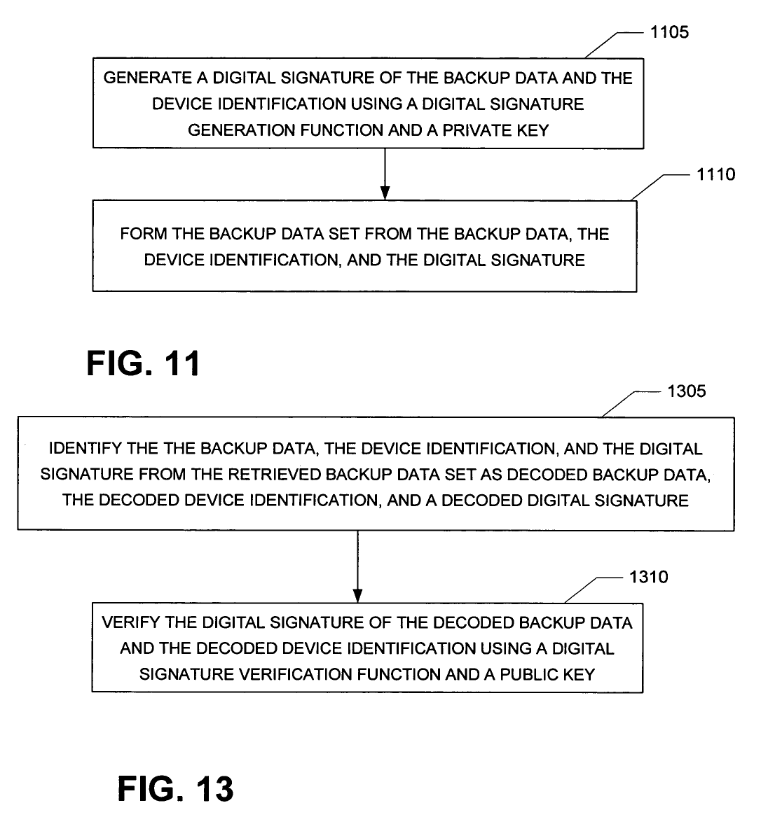

Referring to FIGS. 11, 12, 13, and 14, flow charts of methods and data flow diagrams for the encoding and decoding of the backup data set are shown, in accordance with embodiments of the present invention of a third type.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular secure data backup and recovery technique in accordance with the present invention, it should be observed that the present invention resides primarily in combinations of method steps and apparatus components related to data backup and recovery. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

Referring to FIG. 1, a functional block diagram shows portions of an electronic device 100 and a backup memory 180, in accordance with some embodiments of the present invention. The electronic device 100 comprises a read/write memory 120 that is coupled to a trusted backup and recovery function 125 that can encode a portion of the data in the read/write memory 120 that has been identified as backup data, and send the encoded backup data to be stored in a backup memory 180, which may also be read/write memory. Each of the read/write memory 120 and the backup memory 180 is a logical set of memory that may be a portion of one, or may be one or more, of many types of physical memory, such as integrated circuit, hard disk, floppy disk, memory card, memory stick, etc.

In some embodiments the electronic device 100 is a wireless communication device such as a telephone handset, and the backup memory 180 is located in another electronic device that is accessed by a wireless link 170 that is established in response to the trusted backup and recovery function 125 sending the encoded data. In other embodiments, the electronic device 100 may be a wireless handset or one of many other types of electronic device (such as a desktop computer, gaming set, TV set top box, etc.) and the backup memory 180 is coupled to the electronic device 100 either temporarily or permanently. For example, the backup memory 180 could be a memory stick that plugs into the electronic device 100, or an external hard drive. In these instances, the link 170 may be a wired link. It will also be appreciated that the electronic device 100 could be any electronic apparatus or an integrated circuit or similar apparatus that is capable of performing the functions described herein, when properly powered and coupled to input-output circuits and functions.

The trusted backup and recovery function 125 is coupled to a data backup user interface function 105 to provide means for a user to select some data for backup and determine when and where the selected data is backed up. In some applications of the present invention, the user may be allowed to select which data stored in the read/write memory 120 is backup data. For example, such backup data may include any data that the user has generated, or acquired, which may include software applications that the user has purchased. Backing up such data becomes practical because the unique design of the present invention assures that although the backup data may be received and stored by any electronic device, it is usable only in the electronic device 100 from which it has been backed up. This can be very helpful for users who purchase rights to use software applications and wish to restore the application and related configuration data in the event of corruption of the application or configuration data in the read/write memory 120. In other applications of the present invention, however, the backup data may be pre-defined so that the user has no control over data selection. For instance, the trusted backup and recovery function 125 may backup the entire image of the data in the read/write memory 120, which could include data that is related to operating system functions of the electronic device 100.

In order to accomplish these unique aspects of the present invention, the electronic device 100 has a unique and unalterable identification (ID) 115 and a cryptographic key 110 that are coupled to the trusted backup and recovery function 125. The trusted backup and recovery function 125 is incorporated with the electronic device 100 in such a way that an entity whose data (such as a software program) is being backed up by it has adequate assurance that the necessary functions of the trusted backup and recovery function 125 are essentially unalterable. “Essentially unalterable” means that the task of accomplishing alterations is impractical—for example, the functions may be performed by program code that resides in read-only memory implemented within the same integrated circuit (IC) as the processor used for executing the code.

The characteristics of the unique and unalterable ID 115 are described by its name: the unique and unalterable ID 115 should be essentially unique to the electronic device 100 (within a set of all electronic devices that could also use the data that is backed up), and should be essentially unalterable. “Essentially unique” simply means that the odds of another electronic device that is capable of receiving the backup data set having the same unique and unalterable ID 115 are appropriately small. This can be accomplished by techniques known in the art, such as large random numbers, or assigned numbers, or some combination thereof. The length and complexity of the unique and unalterable ID 115 are therefore related to the number of electronic devices that might be able to operate on, or otherwise use, the data in the backup data set. “Essentially unalterable” for the ID may be an ID stored in a read-only, laser-trimmed integrated circuit ID. Alternatively, the ID may, for example, be stored in one-time programmable memory or electronically programmable fuses implemented within the same IC that has a processor and a random access memory that are used for executing the functions of the trusted backup and recovery function 125. The unique and unalterable ID 115 may not need to be kept secret; in some embodiments it may be desirable for the unique and unalterable ID 115 to be displayable.

The cryptographic key 110 is a set of data that is used in the electronic device 100 during generation of the encoded backup data set and during restoration of the backup data from the encoded backup data set. The cryptographic key 110 may be a symmetric key or a public and private key pair. In a public/private key based system, the private key must be secret, whereas the public key need not be. A symmetric key must be secret. “Secret” may imply that the key cannot be known to the user. The symmetric key is unreadable by all but an authorized entity. Preferably, the trusted backup and recovery function 125 is an authorized entity. The length and complexity of the cryptographic key 110 are related to the type of security used in an embodiment of the electronic device 100 and the amount of resistance to cryptanalysis that is desired.

Referring to FIG. 2, a flow chart of a method for secure data backup and recovery is shown, in accordance with some embodiments of the present invention. At step 205, the data to be backed up is identified. As described above with reference to FIG. 1, this may be done with input from the user, as restricted by the trusted backup and recovery function 125. Alternatively, it could, for instance, be an automatic backup of all data that meets requirements stored in the trusted backup and recovery function 125, or it could be prompted by a message received by the electronic device 100 (with any selection of data perhaps having to be authorized by the trusted backup and recovery function 125). At step 210, the backup data and the unique and unalterable ID 115 (hereafter called the device ID 115) are encoded for integrity and authentication using the cryptographic key 110 and an integrity function, generating a backup data set. This step is performed by a trusted backup function of the trusted backup and recovery function 125 that includes the integrity function. “Integrity” in this context means that assurance can be obtained that the backup data and device ID have not been altered in a backup data set that is received by the electronic device 100. “Authentication” in this context means that only the electronic device 100 that has the device ID 115 used to generate the backup data set can use a received backup data set to restore the backup data.

At step 215, the backup data set is stored by the electronic device 110 in a backup memory 180, which, as described above with reference to FIG. 1, may be one of a variety of types and which may be located locally or remotely. The storage is initiated by the trusted backup and recovery function 125 and may be completed by other functions within and outside the electronic device 100 (e.g., message formatters, radio frequency transmitter and receiver, etc.). At step 216, a retrieved backup data set is presented to the trusted backup and recovery function 125, which generates decoded backup data and decoded device identification and an integrity value by decoding the retrieved backup data set at step 220 using the integrity function of the trusted backup and recovery function 125 and the cryptographic key 110. At step 225, the decoded backup data is used to restore the backup data only when the integrity of the backup data set has been verified at step 220 and the decoded device identification and the device ID 115 match.

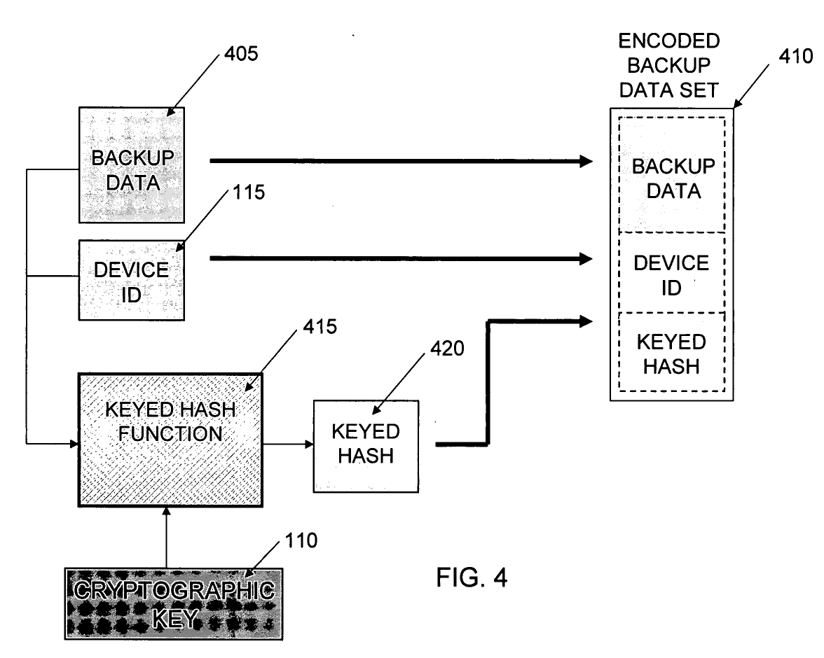

Referring to FIGS. 3 and 4, a flow chart of a method and a data flow diagram for the encoding 210 of the backup data set are shown, in accordance with embodiments of the present invention of a first type. At step 305 (FIG. 3), a keyed hash 420 (FIG. 4) of the backup data 405 and the device ID 115 is generated, using the cryptographic key 110 and a keyed hash function 415. By this is meant that a keyed hash function is performed on a set of data that comprises both the backup data 405 and the device ID 115. The keyed hash 420 may be generated by a well known function such as HMAC (hash-based message authentication code), using a well known hash function such as SHA-1 (secure hash algorithm—version 1). At step 310 (FIG. 3), the encoded backup data set 410 is formed from the backup data 405, the device ID 115 and the keyed hash 420.

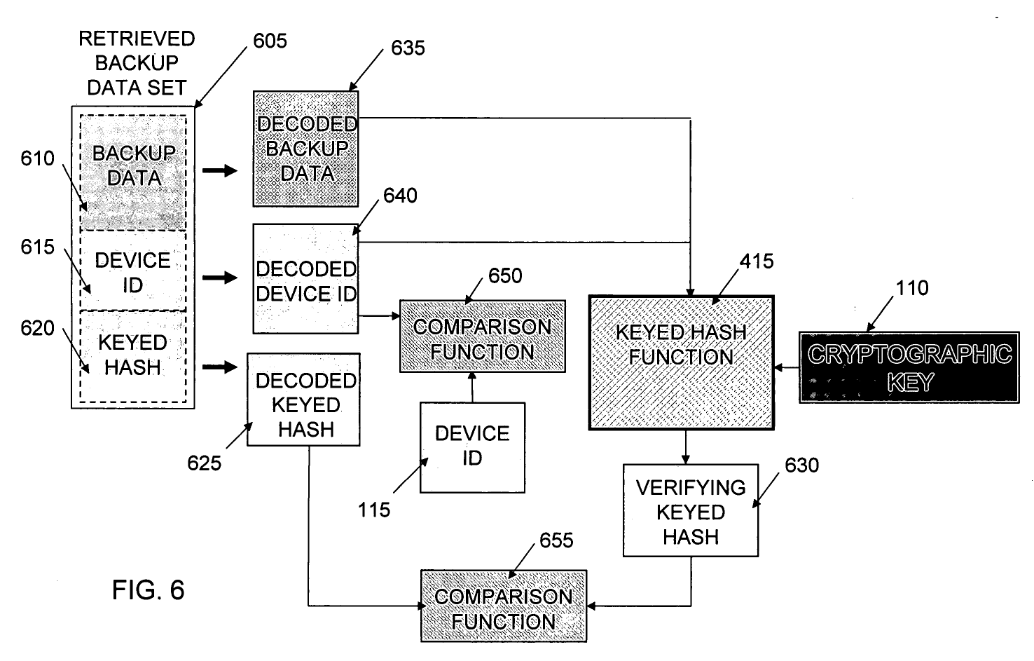

Referring to FIGS. 5 and 6, a flow chart of a method and a data flow diagram for the decoding 220 of the retrieved backup data set are shown, in accordance with the embodiments of the present invention of the first type. At step 505 (FIG. 5), the backup data 610 (FIG. 6), the device identification 615, and the keyed hash 620 in the retrieved backup data set 605 are identified, respectively, to be the decoded backup data 635, the decoded device identification 640, and the decoded keyed hash 625. The respective decoded data sets 635, 640, 625 are identical to the data sets 405, 115, 420 (FIG. 4) that formed the encoded backup data set 410 that was stored only when no data errors have occurred in, and no intentional data changes have been made to, the encoded backup data set 410 during the steps of storage 215 and retrieval 216. The same keyed hash function 415 used at step 305 is used at step 510 (FIG. 5) to encode the decoded backup data 635 and decoded device ID 640, which involves the use of the cryptographic key 110, thus generating a verifying keyed hash 630. When the verifying keyed hash 630 matches the decoded keyed hash 625 using the comparison function 655 at step 515, integrity of the data is established; otherwise integrity has failed. When the integrity has failed, the backup data 610 from the retrieved backup data set 605 cannot be used to restore the original backup data 405. In these embodiments of the first type, the integrity function includes the keyed hash function 415 and the matching 515 of the decoded 625 and verifying 630 keyed hashes. The cryptographic key 110 is a symmetric key.

As described above with reference to FIG. 2, the decoded device ID 640 recovered from the retrieved backup data set 605 is compared to the device ID 115 at step 225 using comparison function 650, and when they match and the integrity has been established, the decoded backup data 635 from the retrieved backup data set 605 may be used to restore the original backup data 405. The matching of the device IDs at step 225 may be done in any order with reference to steps 510 and 515.

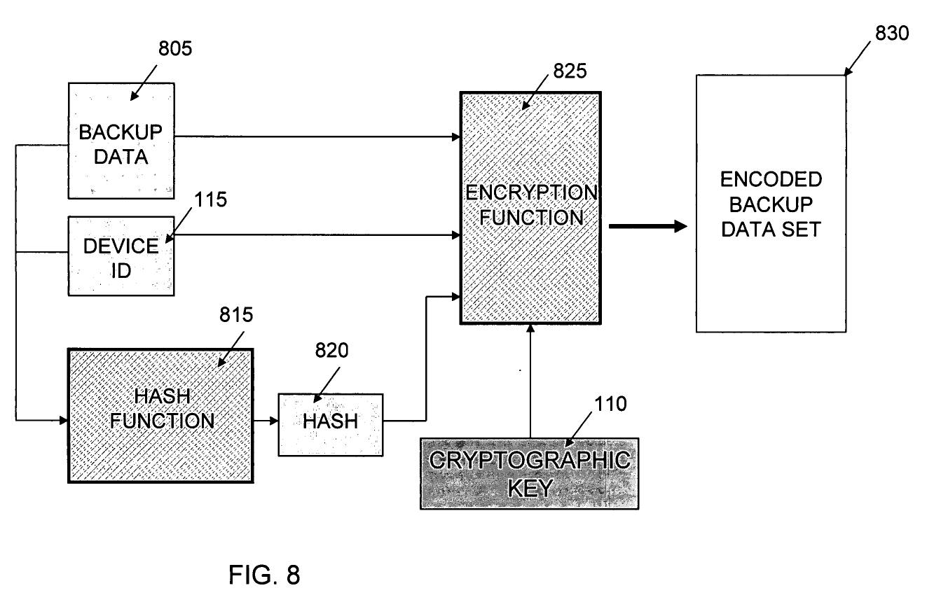

Referring to FIGS. 7 and 8, a flow chart of a method and a data flow diagram for the encoding 210 of the backup data set are shown, in accordance with embodiments of the present invention of a second type. At step 705 (FIG. 7), a (non-keyed) hash 820 (FIG. 8) of the backup data 805 and the device ID 115 is generated using a hash function 815. By this is meant that a hash function is performed on a set of data that comprises both the backup data 805 and the device ID 115. The hash 820 may be generated by a well known function such as SHA-1 (secure hash algorithm—version 1). At step 710, an encoded backup data set 830 is formed by encrypting the backup data 805, the device ID 115, and the hash 820 for privacy using the cryptographic key 110 and an encryption function 825.

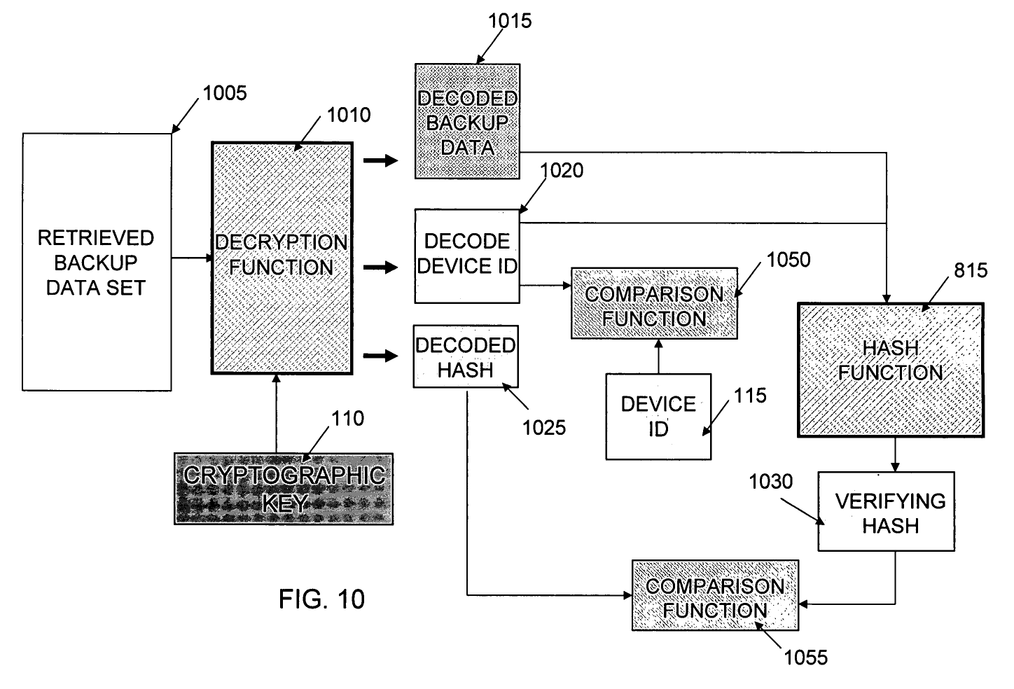

Referring to FIGS. 9 and 10, a flow chart of a method and a data flow diagram for the decoding 220 of the retrieved backup data set are shown, in accordance with the embodiments of the present invention of the second type. A decryption function 1010 (FIG. 10) that is reciprocal to the encryption function 825 (FIG. 8) that was used to encrypt the backup data 805, device ID 115, and hash 820 at step 710 is performed at step 905 (FIG. 9), using the cryptographic key 110. This generates decoded backup data 1015, a decoded device ID 1020, and a decoded hash 1025. These respective decoded data sets 1015, 1020, 1025 are identical to the data sets 805, 115, 820 that formed the encoded backup data set 830 that was stored only when no data errors have occurred in, and no intentional data changes have been made to, the encoded backup data set 830 during the steps of storage 215 and retrieval 216. At step 910, the same hash function 815 used at step 705 is used on the set of data comprising the decoded backup data 1015 and the decoded device ID 1020, generating a verifying hash 1030. When the verifying hash 1030 matches the decoded hash 1025 using the comparison function 1055 at step 915, integrity of the data is established; otherwise integrity has failed. When the integrity has failed, the decoded backup data 1015 from the retrieved backup data set 1005 cannot be used to restore the original backup data 805. In these embodiments of the second type, the integrity function includes the encryption/decryption functions 825, 1010, the hash function 815, and the matching 915 of the decoded 1025 and verifying 1030 hashes. The cryptographic key 110 is a symmetric key.

As described above with reference to FIG. 2, the decoded device ID 1020 recovered from the retrieved backup data set 1005 is compared to the device ID 115 at step 225 using the comparison function 1050, and when they match and the integrity has been established, the decoded backup data 1015 from the retrieved backup data set 1005 may be used to restore the original backup data 805. The matching of the device IDs at step 225 may be done in any order with reference to steps 910 and 915.

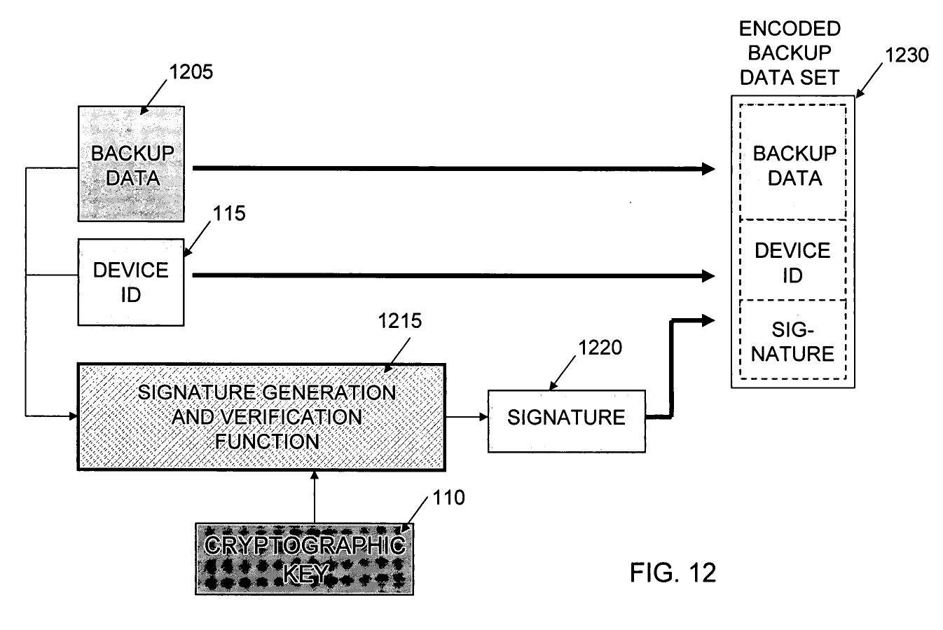

Referring to FIGS. 11 and 12, a flow chart of a method and a data flow diagram for the encoding 210 of the backup data set are shown, in accordance with embodiments of the present invention of a third type. At step 1105 (FIG. 11), a digital signature 1220 (FIG. 12) of the backup data 1205 and the device ID 115 is generated, using a digital signature generation and verfication function 1215 and private key portion of the cryptographic key 110, which comprises a public key and a private key. By this is meant that a digital signature generation function of the digital signature generation and verification function 1215 is performed on a set of data that comprises both the backup data 1205 and the device ID 115. The digital signature 1220 may be generated by a well known function such as RSA (Rivest-Shamir-Adleman algorithm). At step 1110, the encoded backup data set 1230 is formed from the backup data 1205, the device ID 115 and the digital signature 1220.

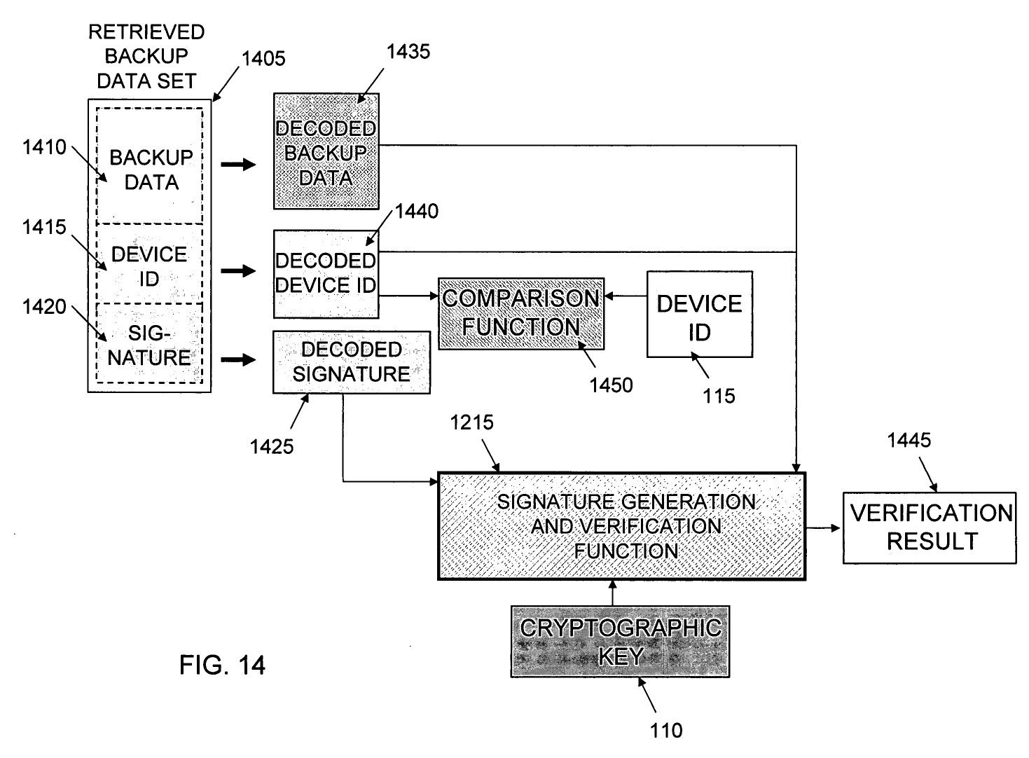

Referring to FIGS. 13 and 14, a flow chart of a method and a data flow diagram for the decoding 220 of the retrieved backup data set are shown, in accordance with the embodiments of the present invention of the third type. At step 1305 (FIG. 13), the backup data 1410, device identification 1415, and digital signature 1420 in the retrieved backup data set 1405 are identified, respectively, to be the decoded backup data 1435, the decoded device identification 1440, and a decoded digital signature 1425. These respective decoded data sets 1435, 1440, 1425 are identical to the data sets 1205, 115, 1220 (FIG. 12) that formed the encoded backup data set 1230 that was stored only when no data errors have occurred in, and no intentional data changes have been made to, the encoded backup data set 1230 during the steps of storage 215 and retrieval 216. The decoded digital signature 1425 is verified at step 1310 by the digital signature verification function of the digital signature generation and verification function 1215, using the decoded backup data 1435, the decoded device ID 1440, and the public key portion of the cryptographic key 110. When the verification result 1445 of the decoded digital signature 1425 is positive, the integrity of the data is established; otherwise integrity has failed. When the integrity has failed, the decoded backup data 1435 from the retrieved backup data set 1405 cannot be used to restore the original backup data 1205. In these embodiments of the third type, the integrity function includes the digital signature generation and verification function 1215. The cryptographic key 110 is a public and private key pair.

As described above with reference to FIG. 2, the decoded device ID 1440 recovered from the retrieved backup data set 1405 is compared to the device ID 115 at step 225 using comparison function 1450, and when they match and the integrity has been established, the decoded backup data 1435 from the retrieved backup data set 1405 may be used to restore the original backup data 1205. The matching of the device IDs at step 225 may be done in any order with reference to step 1310.

It will be appreciated that the secure data backup and recovery technology described herein may be comprised of one or more conventional processors and unique, stored program instructions that control the one or more processors to implement some, most, or all of the functions of secure data backup and recovery described herein; as such, these functions may be interpreted as steps of a method to perform secure data backup and recovery. Alternatively, some or all of these functions could be implemented by a state machine that has no stored program instructions, in which each function or some combinations of certain of the functions are implemented as custom logic. Of course, a combination of the two approaches could be used. Thus, methods and means for these, or some of these, functions may have been described herein. In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

1. A method for secure data backup and recovery of an electronic device having a device identification that is unique and unalterable, comprising:
identifying backup data;
encoding a backup data set that comprises the backup data and the device identification for integrity and authentication using a cryptographic key and an integrity function;
generating decoded backup data and a decoded device identification and verifying integrity by decoding a retrieved backup data set using the cryptographic key and the integrity function;
verifying authenticity by matching the decoded device identification to the device identification; and
restoring the backup data with the decoded backup data only when the integrity and authenticity have been verified.

2. The method according to claim 1, wherein the integrity function uses a hash function on the backup data and the device identification.

3. The method according to claim 1, wherein the cryptographic key is a symmetric key.

4. The method according to claim 3, wherein the symmetric key is a secret key.

5. The method according to claim 1, wherein the cryptographic key is a public/private key pair.

6. The method according to claim 5, wherein the private key is secret.

7. The method according to claim 5, wherein the public key is tamper proof.

8. The method according to claim 1, wherein the cryptographic key is a symmetric key and wherein the encoding comprises:
generating a keyed hash of the backup data and the device identification using the cryptographic key and a keyed hash function; and
forming the backup data set from the backup data, the device identification, and the keyed hash.

9. The method according to claim 8, wherein decoding the retrieved backup data set comprises:
identifying the backup data, the device identification, and the keyed hash from the retrieved backup data set to be the decoded backup data, the decoded device identification, and a decoded keyed hash;
generating a verifying keyed hash of the decoded backup data and the decoded device identification using the cryptographic key and the keyed hash function; and
comparing the decoded keyed hash to the verifying keyed hash.

10. The method according to claim 1, wherein the cryptographic key is a symmetric key and wherein the encoding comprises:
generating a hash of the backup data and the device identification using a hash function; and
forming the backup data set by encrypting the backup data, the device identification, and the hash for privacy using an encryption/decryption function and the cryptographic key.

11. The method according to claim 10, wherein decoding the retrieved backup data set comprises:
decrypting the retrieved backup data set to generate the decoded backup data, the decoded device identification, and a decoded hash using the cryptographic key and the encryption/decryption function;
generating a verifying hash of the decoded backup data and the decoded device identification using the hash function; and
comparing the decoded hash to the verifying hash.

12. The method according to claim 1, wherein the cryptographic key is a public key and private key pair and wherein the encoding comprises:
generating a digital signature of the backup data and the device identification using a digital signature generation function and the private key; and
forming the backup data set from the backup data, the device identification, and the digital signature.

13. The method according to claim 12, wherein decoding the retrieved backup data set comprises:
identifying the backup data, the device identification, and the digital signature from the retrieved backup data set to be the decoded backup data, the decoded device identification, and a decoded digital signature;
verifying the digital signature of the decoded backup data and the decoded device identification using a digital signature verification function, the decoded digital signature, and the public key.

14. The method according to claim 1, wherein the identifying of the backup data is done under control of a trusted backup function that restricts the backup data to be from a defined set of data.

15. The method according to claim 1, further comprising storing and retrieving the encoded backup data set.

16. The method according to claim 15, wherein the backup data set is stored and retrieved by a wireless communication device over a wireless link.

17. The method according to claim 1, wherein the encoding, decoding, and restoring are done under control of a trusted backup function.

18. An apparatus for secure data backup and recovery, comprising:
a memory for at least one of application and user data;
a trusted backup and recovery function that identifies backup data in the memory for secure backup that is a member of a defined set of authorized backup data;
a cryptographic key function that provides a cryptographic key; and
a unique and unalterable device identification, wherein the trusted backup and recovery function
encodes a backup data set that comprises the device identification and the backup data for integrity and authentication using the cryptographic key and an integrity function;
generates decoded backup data and a decoded device identification and verifying integrity by decoding a retrieved backup data set using the cryptographic key and the integrity function;
verifies authenticity by matching the decoded device identification to the device identification; and
restores the backup data with the decoded backup data only when the integrity and authenticity have been verified.

19. An electronic device, comprising:
a memory for at least one of application and user data;
a trusted backup and recovery function that identifies backup data in the memory for secure backup that is a member of a defined set of authorized backup data;
a cryptographic key function that provides a cryptographic key; and
a unique and unalterable device identification, wherein the trusted backup and recovery function
encodes a backup data set that comprises the device identification and the backup data for integrity and authentication using the cryptographic key and an integrity function;
generates decoded backup data and a decoded device identification and verifying integrity by decoding a retrieved backup data set using the cryptographic key and the integrity function;
verifies authenticity by matching the decoded device identification to the device identification; and
restores the backup data with the decoded backup data only when the integrity and authenticity have been verified.
